(19) United States
(12) Patent Application Publication
(10) Pub. No.: US 2025/0376639 A1
(43) Pub. Date: Dec. 11, 2025

(54) DETERGENT FOR STRENGTHENING TEXTILE STRUCTURE

(71) Applicant: HENKEL AG & CO. KGAA, Düsseldorf (DE)

(72) Inventors: Nuria Sanchez BASTARDO, Essen (DE); Ramona JASNY, Mettmann (DE); Jessica WELZEL, Hamburg (DE); Christian KROPF, Hilden (DE); Nicole BODE, Düsseldorf (DE)

(21) Appl. No.: 19/226,197

(22) Filed: Jun. 3, 2025

(30) Foreign Application Priority Data
Jun. 10, 2024 (DE) 102024205311.2

(51) Int. Cl. C11D 3/20; C11D 1/14; C11D 1/22; C11D 1/72; C11D 1/83; C11D 17/04

(52) U.S. Cl. CPC C11D 3/2072; C11D 1/83; C11D 17/042; C11D 1/146; C11D 1/22; C11D 1/72

(57) ABSTRACT

A detergent that includes at least one specific alpha-substituted compound is described. Use of the detergent for reducing the tensile strength loss of textiles during the washing process is also described.

### CROSS REFERENCE TO RELATED APPLICATIONS

This application claims the benefit of German Patent App. No. 10 2024 205311.2, filed Jun. 10, 2024, the disclosure of which is hereby incorporated by reference herein.

### FIELD OF THE INVENTION

The invention relates to detergent comprising specific alpha-substituted compounds.

### BACKGROUND

The invention further relates to the use of the detergent for improving the fiber properties of textile two-dimensional structures washed therewith, in particular for reducing the tensile strength loss of textile two-dimensional structures, such as wool and/or cotton fibers, during the washing process, and to a method for reducing the tensile strength loss of textile two-dimensional structures during the washing process, in which washing is carried out with a detergent containing specific alpha-substituted compounds.

In the dynamic world of ‘fast fashion’, the demand for sustainable practices has become essential. Laundry washing affects the lifespan of textiles and not only influences the individual consumer experience, but also has environmental implications.

Textile two-dimensional structures lose fiber strength over the course of their lifespan. This can occur during wearing, for example through friction, stretching, abrasion and repeated stress, as well as due to environmental influences. On the other hand, textile two-dimensional structures can also be subjected to stress during the washing process due to factors such as mechanical or chemical influences.

In extreme cases, a loss of fiber or tensile strength can result in damage to the textiles.

Washing textiles less frequently can reduce the tensile strength loss. However, a solution for strengthening textile fibers that does not impair and/or significantly change the required washing process is desirable.

The search for a way to increase or stabilize the fiber strength or tensile strength of textile two-dimensional structures is therefore crucial when it comes to extending the lifespan of clothing and thus reducing environmental impact and increasing consumer satisfaction.

The international patent application WO 03/083204 discloses the use of polycarboxylic acids or their derivatives, catalysts and thermoplastic elastomers in fabric softener formulations in order to improve the dimensional stability of textile fabrics.

### SUMMARY OF THE INVENTION

Surprisingly, it was found that detergents based on specific alpha-substituted compounds lead to a significant improvement in fiber and textile properties in a washing process.

The present invention therefore relates, in a first embodiment, to a detergent which contains—based on its total weight—0.000001-2.0 wt. % of at least one alpha-substituted compound of the general formula (I)

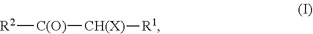

in which
   one of the functional groups R¹ or R² stands for H and the other stands for a straight-chain or branched, saturated or unsaturated alkyl group having 1 to 15 carbon atoms, where the carbon chain can optionally be substituted by one or more hydroxyl or amino groups, and
   X stands for —OH, —NH₂, —Cl, —Br, —I or for the following groupings: —O—(CH₂)ₙ—CH₃, where n means the numbers 1, 2, 3 or 4, and —O—(CH₂)ₘ—OH, where m means the numbers 1, 2 or 3.

### DETAILED DESCRIPTION OF THE INVENTION

Detergents in accordance with the first subject of the invention impart significantly improved fiber and textile properties to textiles washed therewith, in particular improved tensile strength and dimensional stability.

The subjects of the invention and preferred embodiments are characterized by the following statements:
1. A detergent containing—based on its total weight—0.000001-2.0 wt. % of at least one alpha-substituted compound of general formula (I)

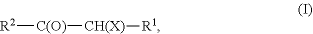

where
   one of the functional groups R¹ or R² stands for H and the other stands for a straight-chain or branched, saturated or unsaturated alkyl group having 1 to 15 carbon atoms, where the carbon chain can optionally be substituted by one or more hydroxyl or amino groups, and
   X stands for —OH, —NH₂, —Cl, —Br, —I or for the following groupings: —O—(CH₂)ₙ—CH₃, where n means the numbers 1, 2, 3 or 4, and —O—(CH₂)ₘ—OH, where m means the numbers 1, 2 or 3.
2. The detergent in accordance with statement 1, wherein in formula (I)
   one of the functional groups R¹ or R² stands for H or for a group —(CH₂)ₒ—CH₃, where o stands for the numbers 3, 4, 5, 6, 7, 8, 9 or 10, and
   X means a hydroxyl group.
3. The detergent in accordance with one of the preceding statements, containing, as alpha-substituted compound in accordance with formula (I), alpha-hydroxyoctanal, alpha-hydroxyoctanone or mixtures thereof.
4. The detergent in accordance with one of the preceding statements, containing at least one surfactant in an amount of 1 to 40 wt. %, based on the total weight of the detergent.
5. The detergent in accordance with one of the preceding statements, containing at least one anionic surfactant.
6. The detergent in accordance with one of the preceding statements, containing at least one anionic surfactant selected from the group of linear or branched alkylbenzenesulfonates i) and/or alkyl ether sulfates ii) and/or alpha-olefin sulfonates iii).
7. The detergent in accordance with one of the preceding statements, containing at least one linear or branched alkylbenzene sulfonate and at least one alkyl ether sulfate.
8. The detergent in accordance with one of the preceding statements, containing at least one anionic surfactant in an amount of 1 to 15 wt. %, based on the total weight of the detergent.
9. The detergent in accordance with one of the preceding statements, containing at least one non-ionic surfactant.
10. The detergent in accordance with one of the preceding statements, containing at least one non-ionic surfactant, selected from the group of alkoxylated fatty alcohols, alkoxylated fatty acid alkyl esters, fatty acid amides, alkoxylated fatty acid amides, polyhydroxy fatty acid amides, alkylphenol polyglycol ethers, amine oxides, alkyl polyglucosides and mixtures thereof.
11. The detergent in accordance with one of the preceding statements, containing at least one non-ionic surfactant, selected from the group of fatty alcohol ethoxylates.
12. The detergent in accordance with one of the preceding statements, containing at least one non-ionic surfactant, selected from C₁₂₋₁₈ alcohol ethoxylates with 2, 3, 4, 5, 6 or 7 EO units.
13. The detergent in accordance with one of the preceding statements, containing at least one non-ionic surfactant in an amount of 0.1 to 30 wt. %, based on the total weight of the detergent.
14. The detergent in accordance with one of the preceding statements, containing at least one further component, wherein the at least one further component is selected from builders, bleaching agents, bleach catalysts, bleach activators, enzymes, electrolytes, pH adjusters, perfumes, perfume carriers, fluorescing agents, dyes, hydrotropic substances, suds suppressors, silicone oils, soil release polymers, graying inhibitors, shrinkage preventers, anti-crease agents, antimicrobial active ingredients, non-aqueous solvents, germicides, fungicides, antioxidants, preservatives, corrosion inhibitors, antistatic agents, bittering agents, ironing aids, phobicizing and impregnating agents, skin care active ingredients, anti-swelling and anti-slip agents, softening components and UV absorbers and mixtures thereof; and wherein the further component is present in an amount of 0.0001 to 30 wt. %, based on the total weight of the detergent.
15. The detergent in accordance with one of the preceding statements, wherein the agent is in solid, liquid or gel form, preferably in liquid, aqueous form and/or in unit dosage form.
16. The use of a detergent in accordance with one of statements 1 to 15 for improving the fiber properties of textile two-dimensional structures washed therewith.
17. The use of a detergent in accordance with one of claims 1 to 15 for reducing the tensile strength loss of textile two-dimensional structures during the washing process.
18. The use of a detergent in accordance with one of claims 1 to 15 for reducing the tensile strength loss of wool and/or cotton fibers during the washing process.
19. The use of compounds according to the general formula (I),

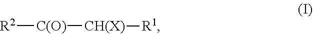

where
   one of the functional groups R¹ or R² stands for H and the other stands for a straight-chain or branched, saturated or unsaturated alkyl group having 1 to 15 carbon atoms, where the carbon chain can optionally be substituted by one or more hydroxyl or amino groups, and
   X stands for —OH, —NH₂, —Cl, —Br, —I or for the following groupings: —O—(CH₂)ₙ—CH₃, where n means the numbers 1, 2, 3 or 4, and —O—(CH₂)ₘ—OH, where m means the numbers 1, 2 or 3, for reducing the tensile strength loss of textile two-dimensional structures during the washing process.
20. A method for reducing the tensile strength loss of textile two-dimensional structures during the washing process, in which the textiles are washed with a detergent containing at least one alpha-substituted compound of the general formula (I)

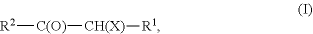

in which C
   one of the functional groups R¹ or R² stands for H and the other stands for a straight-chain or branched, saturated or unsaturated alkyl group having 1 to 15 carbon atoms, where the carbon chain can optionally be substituted by one or more hydroxyl or amino groups, and
   X stands for —OH, —NH₂, —Cl, —Br, —I or for the following groupings: —O—(CH₂)ₙ—CH₃, where n means the numbers 1, 2, 3 or 4, and —O—(CH₂)ₘ—OH, where m means the numbers 1, 2 or 3.

Suitable alpha-substituted compounds in accordance with general formula (I) are preferably those compounds in which one of the functional groups R¹, R² stands for H and the other for a saturated alkyl group having 1 to 15 carbon atoms.

Particularly preferred are alpha-substituted compounds according to formula (I) in which one of the functional groups R¹, R² stands for H and the other for a group —(CH₂)ₒ—CH₃, where o means the numbers 3, 4, 5, 6, 7, 8, 9 or 10.

Very particularly preferably, one of the functional groups R¹ or R² stands for H and the other functional group stands for a butyl, pentyl, hexyl, heptyl or octyl group.

Particularly preferably, one of the functional groups R¹ or R² stands for H and the other functional group stands for a hexyl group.

Further preferred are alpha-substituted compounds according to formula (I) in which the substituent X stands for a hydroxyl group or an amino group.

Particularly preferably, X stands for a hydroxyl group.

According to a preferred embodiment, detergents according to the invention contain alpha-substituted compounds of general formula (I) in which
one of the functional groups R¹, R² stands for H or for a group —(CH₂)ₒ—CH₃, where o stands for the numbers 3, 4, 5, 6, 7, 8, 9 or 10, and
X means a hydroxyl group.

Within this embodiment, particularly preferred alpha-substituted compounds of general formula (I) are those selected from alpha-hydroxybutanal, alpha-hydroxypentanal, alpha-hydroxyhexanal, alpha-hydroxyheptanal, alpha-hydroxyoctanal, alpha-hydroxybutanone, alpha-hydroxypentanone, alpha-hydroxyhexanone, alpha-hydroxyheptanone, alpha-hydroxyoctanone or mixtures thereof.

Particularly preferred are detergents that contain alpha-hydroxyoctanal, alpha-hydroxyoctanone or mixtures thereof.

The detergents in accordance with the invention contain compounds in accordance with general formula (I) in a weight proportion of 0.000001-2.0 wt. %, more preferably 0.00001-1.5 wt. %, particularly preferably 0.0001-1 wt. % and in particular 0.0005-0.8 wt. % of the total weight of the detergent.

Detergents according to the invention particularly preferably contain alpha-hydroxyoctanal, alpha-hydroxyoctanone or mixtures thereof in the aforementioned amounts.

In the scope of this invention, detergents are understood to mean laundry pretreatment agents, detergents, and agents for conditioning textile two-dimensional structures, such as delicate detergents and aftertreatment agents, as well as fabric softeners. Conditioning means the enhancing treatment of textile two-dimensional structures, materials, yarns and woven fabrics. The conditioning is intended to give the textiles positive properties, such as improved softness, increased shine and color brilliance, as well as a reduction in creasing and static charge.

The detergents according to the invention can be in solid form, for example as a powder, granulate, extrudate, pressed and/or melted shaped body, such as a tablet, or in liquid form, for example as a dispersion, suspension, emulsion, solution, microemulsion, gel or paste.

In a preferred embodiment of the invention, the detergents are liquid and in particular water-containing and/or in unit dosage form and contain the active ingredient(s) a) in solution. The solubility of the active ingredient(s) according to formula (I) can be further improved by the presence of surfactants.

Detergents according to the invention therefore preferably contain further components that are commonly found in detergents and do not interact negatively with the aforementioned active ingredients to an unreasonable extent during storage and use.

In a preferred embodiment, detergents according to the invention contain at least one surfactant in an amount of 1 to 40 wt. % of the total weight of the detergent.

In a further preferred embodiment, detergents according to the invention contain at least one anionic surfactant.

The use of anionic surfactants increases the soil release behavior of the agents according to the invention during the washing process without impairing the effect of the active ingredient according to formula (I).

Suitable anionic surfactants within the meaning of the present invention are, for example, those of the sulfonate and sulfate type.

Surfactants of the sulfonate type that can be used are preferably C₉₋₁₃ alkylbenzene sulfonates, olefin sulfonates, i.e. mixtures of alkene and hydroxyalkane sulfonates, and disulfonates, as obtained, for example, from C₁₂₋₁₈ monoolefins having a terminal or internal double bond by way of sulfonation with gaseous sulfur trioxide and subsequent alkaline or acid hydrolysis of the sulfonation products. Also suitable are alkane sulfonates obtained from C₁₂₋₁₈ alkanes, for example by way of sulfochlorination or sulfoxidation with subsequent hydrolysis or neutralization. Likewise, the esters of α-sulfofatty acids (ester sulfonates) are suitable, for example the α-sulfonated methyl esters of hydrogenated coconut fatty acids, palm kernel fatty acids or tallow fatty acids.

Sulfated fatty acid glycerol esters are further suitable anionic surfactants. Fatty acid glycerol esters shall be understood to mean the monoesters, diesters and triesters and the mixtures thereof, as they are obtained during production by way of the esterification of a monoglycerol with 1 to 3 moles fatty acid or during the transesterification of triglycerides with 0.3 to 2 moles glycerol. Preferred sulfated fatty acid glycerol esters are the sulfation products of saturated fatty acids with 6 to 22 carbon atoms, for example caproic acid, caprylic acid, capric acid, myristic acid, lauric acid, palmitic acid, stearic acid or behenic acid.

The alkali salts and in particular the sodium salts of the sulfuric acid half-esters of C₁₂-C₁₈ fatty alcohols, for example from coconut fatty alcohol, tallow fatty alcohol, lauryl alcohol, myristyl alcohol, cetyl alcohol or stearyl alcohol, or of C₁₀-C₂₀ oxo alcohols and the half-esters of secondary alcohols having these chain lengths are preferred as alk(en)yl sulfates. Alk(en)yl sulfates of the mentioned chain length that contain a synthetic straight-chain alkyl functional group prepared on a petrochemical basis and have a degradation behavior similar to that of the adequate compounds based on fat chemical raw materials are also preferred. From a washing perspective, C₁₂-C₁₆ alkyl sulfates, C₁₂-C₁₅ alkyl sulfates and C₁₄₋₁₅ alkyl sulfates are preferred. 2,3-alkyl sulfates, which can be obtained, for example, as commercial products under the name DAN® from the Shell Oil Company, are also suitable anionic surfactants.

The sulfuric acid monoesters of the straight-chain or branched C₇₋₂₁ alcohols ethoxylated with 1 to 6 mol ethylene oxide, such as 2-methyl-branched C₉₋₁₁ alcohols with, on average, 3.5 mol ethylene oxide (EO) or C₁₂₋₁₈ fatty alcohols with 1 to 4 EO, which are referred to as fatty alcohol ether sulfates, are also suitable and particularly preferred anionic surfactants within the scope of the present invention.

Further suitable anionic surfactants are also the salts of alkyl sulfosuccinic acid, which are also referred to as sulfosuccinates or as sulfosuccinic acid esters and stand for monoesters and/or diesters of sulfosuccinic acid with alcohols, preferably fatty alcohols, and in particular ethoxylated fatty alcohols. Preferred sulfosuccinates contain C₈₋₁₈ fatty alcohol residues or mixtures of these. Particularly preferred sulfosuccinates contain a fatty alcohol residue which is derived from ethoxylated fatty alcohols, which in themselves represent nonionic surfactants. Sulfosuccinates with fatty alcohol functional groups that are derived from ethoxylated fatty alcohols with a narrow homolog distribution are particularly preferred. Likewise, it is also possible to use alk(en)yl succinic acid having preferably 8 to 18 carbon atoms in the alk(en)yl chain, or the salts thereof.

Further anionic surfactants that can also be used are in particular soaps. For example, the saturated fatty acid soaps are suitable, such as the salts of lauric acid, myristic acid, palmitic acid, stearic acid, hydrogenated erucic acid and behenic acid, and in particular soap mixtures derived from natural fatty acids, such as coconut fatty acids, palm kernel fatty acids or tallow fatty acids.

The anionic surfactants, including the soaps, can be present in the form of the sodium, potassium or ammonium salts thereof, or as soluble salts of organic bases, such as mono-, di- or triethanolamine. The anionic surfactants are preferably present in the form of the sodium or potassium salts thereof, in particular in the form of the sodium salts. However, for the non-aqueous liquid detergents according to the invention, the ammonium salts, in particular the salts of organic bases, such as isopropylamine, are preferred.

Another class of anionic surfactants is the class of ether carboxylic acids, which are accessible by reacting fatty alcohol ethoxylates with sodium chloroacetate in the presence of basic catalysts. They have the general formula: R¹⁰ O—(CH₂—CH₂—O)ₚ—CH₂—COOH, where R¹⁰=C₁-C₁₈, and p=0, 1 to 20. Ether carboxylic acids are insensitive to water hardness and have excellent surfactant properties.

In a preferred embodiment, the detergents according to the invention contain anionic surfactants from the group of fatty alcohol sulfates and/or fatty alcohol ether sulfates and/or linear or branched alkylbenzene sulfonates and/or alpha-olefin sulfonates and/or soaps. They particularly preferably contain linear or branched alkylbenzene sulfonates i) and/or alkyl ether sulfates ii) and/or an alpha-olefin sulfonate iii) and particularly preferably fatty alcohol ether sulfates and linear or branched alkylbenzene sulfonates.

The at least one anionic surfactant can preferably be present in the detergents according to the invention in a weight proportion of 1 to 15 wt. %, more preferably 2 to 15 wt. % and in particular 3 to 15 wt. % of the total weight of the detergent.

In a further preferred embodiment, detergents according to the invention contain at least one non-ionic surfactant.

Preferably used non-ionic surfactants are alkoxylated, advantageously ethoxylated and/or propoxylated, in particular primary alcohols having preferably 8 to 18 C atoms and on average 1 to 12 moles of ethylene oxide (EO) and/or 1 to 10 moles of propylene oxide (PO) per mole of alcohol. Particularly preferred are C₈-C₁₆ alcohol alkoxylates, advantageously ethoxylated and/or propoxylated C₁₀-C₁₅ alcohol alkoxylates, in particular C₁₂-C₁₄ alcohol alkoxylates, having a degree of ethoxylation between 2 and 10, preferably between 3 and 8, and/or a degree of propoxylation between 1 and 6, preferably between 1.5 and 5. The alcohol functional group can preferably be linear or particularly preferably methyl-branched in the 2-position or contain linear and methyl-branched functional groups in the mixture, as are usually present in oxo alcohol functional groups. However, alcohol ethoxylates having linear functional groups of alcohols of native origin having 12 to 18 C atoms, for example of coconut, palm, tallow fatty or oleyl alcohol, and an average of 2 to 8 EO per mol of alcohol, are particularly preferred. Preferred ethoxylated alcohols include, for example, C₁₂₋₁₄ alcohols having 3 EO or 4 EO, C₉₋₁₁ alcohol having 7 EO, C₁₃₋₁₅ alcohols having 3 EO, 5 EO, 7 EO or 8 EO, C₁₂₋₁₈ alcohols having 3 EO, 5 EO or 7 EO and mixtures thereof, such as mixtures of C₁₂₋₁₄ alcohol having 3 EO and C₁₂₋₁₈ alcohol having 5 EO. The stated degrees of ethoxylation and propoxylation are statistical averages, which can be an integer or a fractional number for a specific product. Preferred alcohol ethoxylates and propoxylates have a narrowed homolog distribution (narrow range ethoxylates/propoxylates, NRE/NRP). In addition to these non-ionic surfactants, fatty alcohols having more than 12 EO can also be used. Examples of these are tallow fatty alcohols having 14 EO, 25 EO, 30 EO, or 40 EO.

Also suitable are alkoxylated amines, advantageously ethoxylated and/or propoxylated, in particular primary and secondary amines having preferably 1 to 18 C atoms per alkyl chain and on average 1 to 12 moles of ethylene oxide (EO) and/or 1 to 10 moles of propylene oxide (PO) per mole of amine.

The end-capped alkoxylated fatty amines and fatty alcohols have proven to be particularly advantageous, in particular for use in non-aqueous formulations according to the invention. The terminal hydroxy groups of the fatty alcohol alkoxylates and fatty amine alkoxylates in the end-capped fatty alcohol alkoxylates and fatty amine alkoxylates are etherified by C₁-C₂₀ alkyl groups, preferably methyl or ethyl groups.

Moreover, alkyl glycosides of the general formula RO(G)ₓ can also be used as further non-ionic surfactants, for example as compounds, particularly with anionic surfactants, in which R is a primary straight-chain or methyl-branched, aliphatic functional group, in particular an aliphatic functional group that is methyl-branched in the 2 position, having 8 to 22, preferably 12 to 18, C atoms, and G is the symbol that stands for a glycose unit having 5 or 6 C atoms, preferably glucose. The degree of oligomerization x, which indicates the distribution of monoglycosides and oligoglycosides, is any number between 1 and 10; x is preferably between 1.2 and 1.4.

Another class of non-ionic surfactants that are preferably used, which are used either as the sole non-ionic surfactant or in combination with other non-ionic surfactants, is alkoxylated, preferably ethoxylated or ethoxylated and propoxylated fatty acid alkyl esters, preferably having 1 to 4 carbon atoms in the alkyl chain, in particular fatty acid methyl esters.

Surfactants known as gemini surfactants can also be considered. These are generally understood to mean those compounds that have two hydrophilic groups and two hydrophobic groups per molecule. These groups are generally separated from one another by a so-called “spacer.” This spacer is generally a carbon chain that should be long enough that the hydrophilic groups are sufficiently spaced apart so that they can act independently of one another. Such surfactants are generally characterized by an unusually low critical micelle concentration and the ability to greatly reduce the surface tension of the water. In exceptional cases, however, the expression gemini surfactants is understood to mean not only dimeric but also trimeric surfactants.

Suitable gemini surfactants are, for example, sulfated hydroxy mixed ethers or dimer alcohol bis- and trimer alcohol tris sulfates and ether sulfates. End-capped dimeric and trimeric mixed ethers are characterized in particular by their bi- and multifunctionality. The aforementioned end-capped surfactants thus have good wetting properties and are low-foaming, which means that they are particularly suitable for use in machine washing or cleaning processes. However, gemini polyhydroxy fatty acid amides or poly-polyhydroxy fatty acid amides can also be used.

Other suitable surfactants are polyhydroxy fatty acid amides of the following formula,

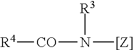

where R⁴CO stands for an aliphatic acyl functional group having 6 to 22 carbon atoms, R³ stands for hydrogen, an alkyl or hydroxy alkyl functional group having 1 to 4 carbon atoms, and [Z] stands for a linear or branched polyhydroxyalkyl functional group having 3 to 10 carbon atoms and 3 to 10 hydroxyl groups. The polyhydroxy fatty acid amides are known substances that can usually be obtained by the reductive amination of a reducing sugar with ammonia, an alkyl amine or an alkanol amine, and subsequent acylation with a fatty acid, a fatty acid alkyl ester or a fatty acid chloride.

The group of the polyhydroxy fatty acid amides also includes compounds of the following formula,

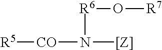

where R⁵ stands for a linear or branched alkyl or alkenyl functional group having 7 to 12 carbon atoms, R⁶ stands for a linear, branched or cyclic alkyl functional group or an aryl functional group having 2 to 8 carbon atoms, and R⁷ stands for a linear, branched or cyclic alkyl functional group or an aryl functional group or an oxy alkyl functional group having 1 to 8 carbon atoms, wherein C₁₋₄ alkyl or phenyl functional groups are preferred, and [Z] stands for a linear polyhydroxyalkyl functional group, the alkyl chain of which is substituted with at least two hydroxyl groups, or alkoxylated, preferably ethoxylated or propoxylated derivatives of this functional group. [Z] is preferably obtained by the reductive amination of a reduced sugar, for example glucose, fructose, maltose, lactose, galactose, mannose or xylose. The N-alkoxy- or N-aryloxy-substituted compounds can then be converted into the desired polyhydroxy fatty acid amides, for example by reaction with fatty acid methyl esters in the presence of an alkoxide as catalyst.

For the detergents according to the invention, it has been found to be advantageous if non-ionic surfactants selected from the group of the alkoxylated fatty alcohols and/or alkyl glycosides are used.

A content of non-ionic surfactants from the group of the alkoxylated fatty alcohols (fatty alcohol ethoxylates), preferably C₁₂₋₁₈ alcohol ethoxylates with 2, 3, 4, 5, 6 or 7 EO units and in particular with 7 EO units, are particularly preferred in the scope of the present invention.

In a preferred embodiment, the detergents according to the invention contain non-ionic surfactants in amounts of 0.1 to 30 wt. %, more preferably 0.5 to 20 wt. %, particularly preferably 1 to 15 wt. %, in each case based on the total agent.

In a preferred embodiment of the present invention, the detergents according to the invention contain at least one further component (additive) in addition to the active ingredients already defined.

Preferably, the at least one additive is selected from the group consisting of builders, bleaching agents, bleach catalysts, bleach activators, enzymes, electrolytes, pH adjusters, perfumes, perfume carriers, fluorescing agents, dyes, hydrotropic substances, suds suppressors, silicone oils, soil release polymers, graying inhibitors, shrinkage preventers, anti-crease agents, antimicrobial active ingredients, non-aqueous solvents, germicides, fungicides, antioxidants, preservatives, corrosion inhibitors, antistatic agents, bittering agents, ironing aids, phobicizing and impregnating agents, skin care active ingredients, anti-swelling and anti-slip agents, softening components, and UV absorbers, and mixtures thereof.

More preferably, the at least one additive is present in an amount of 0.0001 to 30 wt. %, preferably 0.1 to 20 wt. %, based on the total weight of the agent.

Builders that can be present in the detergent according to the invention include in particular silicates, aluminum silicates (in particular zeolites), carbonates, salts of organic di- and polycarboxylic acids, and mixtures of these substances.

Suitable crystalline, layered sodium silicates have the general formula NaMSiₓO₂ₓ₊₁·H₂O, where M is sodium or hydrogen, x is a number from 1.9 to 4, and y is a number from 0 to 20, and preferred values for x are 2, 3 or 4. Preferred crystalline phyllosilicates of the aforementioned formula are those in which M stands for sodium and x assumes the values 2 or 3. In particular, both β- and δ-sodium disilicates Na₂Si₂O₅·yH₂O are preferred.

It is also possible to use amorphous sodium silicates with an Na₂O:SiO₂ modulus of 1:2 to 1:3.3, preferably 1:2 to 1:2.8, and in particular 1:2 to 1:2.6, which exhibit retarded dissolution and secondary washing properties. The retarded dissolution compared to conventional amorphous sodium silicates can have been caused in a variety of ways, for example by way of surface treatment, compounding, compacting/compression or over-drying. In the scope of the present invention, the term “amorphous” is also understood to mean “X-ray amorphous”. This means that the silicates do not supply any sharp X-ray reflexes in X-ray diffraction experiments, such as those that are typical of crystalline substances, but at best one or more maxima of the scattered X-ray radiation, which have a width of multiple degree units of the diffraction angle. However, particularly good builder properties may very well also be achieved when the silicate particles supply washed-out or even sharp diffraction maxima in electron diffraction experiments. This is to be interpreted such that the products comprise microcrystalline regions measuring 10 to several hundred nm, with values up to a maximum of 50 nm, and in particular up to a maximum of 20 nm, being preferred. Compressed/compacted amorphous silicates, compounded amorphous silicates and overdried X-ray amorphous silicates are particularly preferred.

The finely crystalline, synthetic zeolite, which contains bound water, is preferably zeolite A and/or P. Zeolite X and mixtures of A, X and/or P are suitable. Commercially available and preferably usable in the scope of the present invention is, for example, a co-crystallizate of zeolite X and zeolite A (approx. 80 wt. % of zeolite X), which can be described by the formula

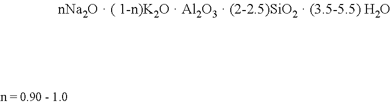

The zeolite may be used as a spray-dried powder or as a non-dried stabilized suspension which is still moist from its preparation process. In the event that the zeolite is used in the form of a suspension, this can contain small amounts of additives of non-ionic surfactants as stabilizers, for example 1 to 3 wt. %, based on zeolite, of ethoxylated C12-C18 fatty alcohols having 2 to 5 ethylene oxide groups, C12-C14 fatty alcohols having 4 to 5 ethylene oxide groups, or ethoxylated isotridecanols. Suitable zeolites have an average particle size of less than 10 m (volume distribution; measuring method: Coulter counter) and preferably contain 18 to 22 wt. %, in particular 20 to 22 wt. %, of bound water.

It is also possible, of course, to use the generally known phosphates as builder substances, provided that such use should not be avoided for ecological reasons. Sodium salts of orthophosphates, pyrophosphates and in particular tripolyphosphates are particularly suitable.

Organic builders that can be present in the detergent are, for example, the polycarboxylic acids that can be used in the form of the sodium salts thereof, polycarboxylic acids being understood to mean those carboxylic acids that carry more than one acid function. These include, for example, citric acid, adipic acid, succinic acid, glutaric acid, malic acid, tartaric acid, maleic acid, fumaric acid, saccharic acids, aminocarboxylic acids, nitrilotriacetic acid (NTA), methyl glycine diacetic acid (MGDA), and derivatives and mixtures thereof. Preferred salts are the salts of polycarboxylic acids, such as citric acid, adipic acid, succinic acid, glutaric acid, tartaric acid, saccharic acids, and mixtures thereof.

The acids can also be used per se. In addition to their builder effect, the acids typically also have the property of being an acidification component and are thus also used to set a lower and milder pH of washing or cleaning agents. Particularly noteworthy here are citric acid, succinic acid, glutaric acid, adipic acid, gluconic acid, and any mixtures thereof. Other known pH regulators, such as sodium hydrogen carbonate and sodium hydrogen sulfate.

Polymeric polycarboxylates are also suitable as builders. These are, for example, the alkali metal salts of polyacrylic acid or of polymethacrylic acid, for example those having a weight-average molecular mass of from 500 to 70,000 g/mol.

Within the meaning of this application, the molar masses indicated for the polymeric polycarboxylates are weight average molar masses MW of the respective acid form, which were generally determined by way of gel permeation chromatography (GPC) in which a UV detector was used. The measurement was carried out against an external polyacrylic acid standard which, due to the structural relationship to the tested polymers, yields realistic molecular weight values.

Suitable polymers are in particular polyacrylates which preferably have a molecular mass of from 2 to 20,000 g/mol. Due to their superior solubility, short-chain polyacrylates having molar masses of from 2,000 to 10,000 g/mol, and particularly preferably of from 3,000 to 5,000 g/mol, may in turn be preferred from this group.

Suitable polymers can also comprise substances consisting partially or completely of units of vinyl alcohol or the derivatives thereof.

In addition, copolymeric polycarboxylates are suitable, in particular those of acrylic acid with methacrylic acid and those of acrylic acid or methacrylic acid with maleic acid. Copolymers of acrylic acid with maleic acid containing 50 to 90 wt. % acrylic acid and 50 to 10 wt. % maleic acid have proven to be particularly suitable. The weight average molecular weight thereof, based on free acids, is generally 2,000 to 70,000 g/mol, preferably 20,000 to 50,000 g/mol, and in particular 30,000 to 40,000 g/mol. The (co)polymeric polycarboxylates can be used either as an aqueous solution or preferably as a powder.

In order to improve water solubility, the polymers can also contain allyl sulfonic acids, such as allyloxybenzene sulfonic acid and methallyl sulfonic acid, as monomers.

Also particularly preferred are biodegradable polymers formed from more than two different monomer units, such as those containing salts of acrylic acid and maleic acid and vinyl alcohol or vinyl alcohol derivatives as monomers, or salts of acrylic acid and 2-alkylallyl sulfonic acid and sugar derivatives as monomers.

Further preferred copolymers preferably contain acrolein and acrylic acid/acrylic acid salts or acrolein and vinyl acetate as monomers.

Polymeric aminodicarboxylic acids, the salts thereof or the precursors thereof should likewise be mentioned as further preferred builders. Polyaspartic acids or the salts and derivatives thereof, which have both builder properties and a bleach-stabilizing effect, are particularly preferred.

Further suitable builders are polyacetals, which can be obtained by reacting dialdehydes with polyol carboxylic acids having 5 to 7 C atoms and at least 3 hydroxyl groups. Preferred polyacetals are obtained from dialdehydes, such as glyoxal, glutaraldehyde, terephthalaldehyde and mixtures thereof, and from polyol carboxylic acids, such as gluconic acid and/or glucoheptonic acid.

Further suitable organic builders are dextrins, for example oligomers or polymers of carbohydrates, which can be obtained by the partial hydrolysis of starches. The hydrolysis can be carried out according to customary methods, for example acid- or enzyme-catalyzed methods. These are preferably hydrolysis products having weight average molecular weights in the range of 400 to 500,000 g/mol. In this case, a polysaccharide having a dextrose equivalent (DE) in the range of from 0.5 to 40, in particular from 2 to 30, is preferred, DE being a customary measure for the reducing effect of a polysaccharide compared to dextrose, which has a DE of 100. It is possible to use both maltodextrins having a DE between 3 and 20 and dried glycose syrups having a DE between 20 and 37, and what are known as yellow dextrins and white dextrins having higher weight average molecular weights in the range of 2,000 to 30,000 g/mol.

Oxidized derivatives of dextrins of this type are the reaction products thereof with oxidizing agents which are capable of oxidizing at least one alcohol function of the saccharide ring to form a carboxylic acid function. An oxidized oligosaccharide is also suitable. A product that is oxidized on C₆ of the saccharide ring can be particularly advantageous.

Oxydisuccinates and other derivatives of disuccinates, preferably ethylenediamine disuccinate, are also suitable builders. In this case, ethylenediamine-N,N′-disuccinate (EDDS) is preferably used in the form of the sodium or magnesium salts thereof. Glycerol disuccinates and glycerol trisuccinates are also preferred in this context.

Further suitable organic builders are, for example, acetylated hydroxycarboxylic acids or the salts thereof, which optionally can also be present in lactone form and contain at least 4 carbon atoms and at least one hydroxy group, as well as no more than two acid groups.

However, for aesthetic reasons, soluble organic builders, such as citric acid, are preferred in aqueous detergents or cleaning agents.

Among the compounds that are used as bleaching agents and supply H₂O₂ in water, sodium perborate tetrahydrate and sodium perborate monohydrate are of particular importance. Other useful bleaching agents are, for example, sodium percarbonate, peroxypyrophosphates, citrate perhydrate and H₂O₂-supplying peracidic salts or organic peracids, such as perbenzoates, peroxophthalates, diperazelaic acid, diperdodecanedioic acid, 4-phthalimidoperoxobutanoic acid, 5-phthalimidoperoxopentanoic acid, 6-phthalimidoperoxohexanoic acid, 7-phthalimidoperoxoheptanoic acid, N,N′-terephthaloyl-di-6-aminoperoxohexanoic acid and mixtures thereof. The preferred peracids include the phthalimidoperoxoalkanoic acids, in particular 6-phthalimidoperoxohexanoic acid (PAP). The bleaching agent can—if present—be provided in particle form using inert carrier materials in a known manner; it is preferably used in coated form. It is important that the coating material releases the coated bleaching agent under the use conditions of the detergent (at higher temperatures, pH changing due to dilution with water, or similar). A preferred coating material is one that consists at least partially of saturated fatty acid.

The amount of bleaching agent is preferably between 0.5 and 20 wt. % based on the total detergent or cleaning agent.

Bleach activators can be incorporated into the detergents to achieve an improved bleaching effect when washing at temperatures of 60° C. and below. Compounds that produce aliphatic peroxocarboxylic acids under perhydrolysis conditions can be used as bleach activators. Polyacylated alkylendiamines, in particular tetraacetylethylenediamine (TAED), acylated triazine derivates, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenol sulfonates, in particular n-nonanoyl or isononanoyl oxybenzene sulfonate (n- or iso-NOBS), carboxylic acid anhydrides, in particular phthalic acid anhydride, acylated polyhydric alcohols, in particular triacetin, ethylene glycol diacetate, and 2,5-diacetoxy-2,5-dihydrofuran are preferred.

In addition to the conventional bleach activators or instead of them, so-called bleach catalysts can also be incorporated into the liquid detergents. These substances are bleach-intensifying transition metal salts or transition metal complexes, such as Mn, Fe, Co, Ru or Mo salen complexes or carbonyl complexes. Mn, Fe, Co, Ru, Mo, Ti, V, and Cu complexes having nitrogen-containing tripod ligands as well as Co, Fe, Cu, and Ru ammine complexes can also be used as bleach catalysts.

If the preferably liquid detergent contains a bleaching agent, a bleach activator and/or a bleach catalyst, it is particularly advantageous for these to be present in encapsulated form in the detergent. However, it is preferred if the detergent does not contain any of these ingredients.

The preferably liquid detergent can also contain an enzyme or a mixture of enzymes. Particularly suitable are those from the classes of hydrolases, such as proteases, (poly)esterases, lipases or lipolytic enzymes, amylases, cellulases or other glycosyl hydrolases, hemicellulase, cutinases, β-glucanases, oxidases, peroxidases, mannanases, perhydrolases, oxireductases and/or laccases. In the scope of the present invention, preference is given to using proteases, amylases, lipases, cellulases, mannanases, laccases, tannanases and esterases/polyesterases, and mixtures of two or more of these enzymes.

The hydrolases help to remove stains, such as those containing protein, fat or starch, and graying in laundry. Cellulases and other glycosyl hydrolases can also contribute to the removal of pilling and microfibrils to maintain color and increase the softness of the textile. Preferably used cellulases are cellobiohydrolases, endoglucanases and β-glucosidases, which are also called cellobiases, or mixtures thereof. Since the different types of cellulases differ in terms of their CMCase and avicelase activities, the desired activities can be adjusted by targeted mixtures of cellulases.

Preferably, subtilisin-type proteases and in particular proteases obtained from Bacillus lentus are used. Mixtures of enzymes, for example proteases and amylases or proteases and lipases or lipolytically active enzymes or proteases and cellulases or enzymes obtained from cellulase and lipase or lipolytically active enzymes or proteases, lipases or lipolytically active enzymes and cellulases, but in particular mixtures containing proteases and/or lipases or mixtures with lipolytically active enzymes, are of particular interest. Examples of such lipolytically active enzymes are the known cutinases. Suitable amylases include in particular α-amylases, isoamylases, pullulanases and pectinases.

The amount of enzyme or enzymes is, based on the total weight of the agent, 0.01 to 10 wt. %, preferably 0.12 to approximately 3 wt. %. The enzymes are preferably used as liquid enzyme formulation(s) in liquid agents. If the washing or cleaning agent contains a mixture of enzymes, at least one enzyme can be in the form of a granulate, encapsulated or adsorbed on carrier substances. Very preferred washing or cleaning agents contain cellulase; cellulase and protease; cellulase, protease and amylase; cellulase, protease, amylase and lipase; or cellulase, protease, amylase, lipase and (poly)esterase.

To stabilize the enzymes, the detergents according to the invention can contain stabilizers, such as boric acid or borates, boric acid derivatives or amino alcohols.

A wide number of different salts can be used as electrolytes from the group of the inorganic salts. Preferred cations are the alkali and alkaline earth metals, preferred anions are the halides and sulfates. The proportion of electrolytes in the detergent is usually 0.1 to 5 wt. %, based on the total weight of the agent.

Liquid agents may contain one or more non-aqueous solvents in addition to the main solvent, water. Non-aqueous solvents that can be used in the detergent or cleaning agent come, for example, from the group of mono- or polyhydric alcohols, alkanolamines or glycol ethers, provided they are miscible with water in the specified concentration range. Solvents can be used that are selected from ethanol, n- or i-propanol, butanols, glycol, propanediol or butanediol, glycerol, diglycol, propyl diglycol or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether or propylene glycol propyl ether, dipropylene glycol monomethyl ether or dipropylene glycolmonoethyl ether, diisopropylene glycol monomethyl ether or diisopropylene glycol monoethyl ether, methoxytriglycol, ethoxytriglycol or butoxytriglycol, 1-butoxyethoxy-2-propanol, 3-methyl-3-methoxybutanol, propylene-glycol-t-butylether, di-n-octylether, and mixtures of these solvents. Non-aqueous solvents can be used in the liquid detergent in amounts between 0.5 and 30 wt. %, but preferably below 20 wt. % and in particular below 15 wt. %.

However, it is preferred for the liquid detergent to contain a polyol as a non-aqueous solvent. The polyol can in particular comprise glycerol, 1,2-propanediol, 1,3-propanediol, ethylene glycol, diethylene glycol and/or dipropylene glycol. Particularly preferably, the liquid detergent contains a mixture of at least two polyols. In this case, mixtures of 1,2-propanediol and dipropylene glycol, 1,2-propanediol and diethylene glycol, or glycerol and diethylene glycol are preferred.

In order to bring the pH of the liquid detergent into the neutral range, the use of pH adjusters may be indicated. All known acids or alkalis can be used here, provided that their use is not prohibited for practical or ecological reasons or for reasons of consumer protection. The amount of these adjusters usually does not exceed 10 wt. % of the total formulation.

A liquid detergent or cleaning agent may contain a thickener. The thickener can, for example, comprise a polyacrylate thickener, xanthan gum, gellan gum, guar gum, alginate, carrageenan, carboxymethylcellulose, bentonite, wellan gum, carob gum, agar-agar, tragacanth, gum arabic, pectins, polyoses, starch, dextrins, gelatin and casein. However, modified natural substances, such as modified starches and celluloses, can also be used as thickeners, for example carboxymethylcellulose and other cellulose ethers, hydroxyethyl cellulose and hydroxypropyl cellulose, and kernel flour ethers.

Polyacrylic and polymethacrylic thickeners include, for example, the high-molecular homopolymers of acrylic acid crosslinked with a polyalkenyl polyether, in particular an allyl ether of saccharose, pentaerythritol or propylene (INCI name in accordance with the “International Dictionary of Cosmetic Ingredients” of “The Cosmetic, Toiletry, and Fragrance Association (CTFA)”: Carbomer), which are also referred to as carboxyvinyl polymers. Such polyacrylic acids are available, inter alia, from the company 3V Sigma under the trade name Polygel®, for example Polygel DA, and from the company Noveon under the trade name Carbopol®, for example Carbopol 940 (molecular weight approximately 4,000,000 g/mol), Carbopol 941 (molecular weight approximately 1,250,000 g/mol) or Carbopol 934 (molecular weight approximately 3,000,000 g/mol). Furthermore, the following acrylic acid copolymers are included: (i) copolymers of two or more monomers from the group of acrylic acid, methacrylic acid and their simple esters, preferably formed with C₁₋₄ alkanols (INCI Acrylates Copolymer), which include for example the copolymers of methacrylic acid, butyl acrylate and methyl methacrylate (CAS designation in accordance with the Chemical Abstracts Service: 25035-69-2) or of butyl acrylate and methyl methacrylate (CAS 25852-37-3) and which are available, for example from the company Evonik under the trade name Tego® Polymer; (ii) crosslinked high-molecular acrylic acid copolymers, which include for example the copolymers of C10-C30 alkyl acrylates crosslinked with an allyl ether of saccharose or pentaerythritol having one or more monomers selected from the group consisting of acrylic acid, methacrylic acid and their simple esters, preferably formed with C1-C4 alkanols (INCI Acrylates/C10-30 Alkyl Acrylate Crosspolymer). Other suitable thickeners based on (meth)acrylic acid (co)polymers comprise Carbopol® Aqua 30 (ex Noveon) or polyacrylate thickeners sold by BASF under the trade name Sokalan®.

The liquid washing or cleaning agents preferably have viscosities in the range from 200 to 5,000 mPas, with values between 300 and 2,000 mPas and in particular 400 and 1,000 mPas being particularly preferred. The viscosity was determined using a Brookfield viscometer LVT-II at 20 rpm and 20° C., spindle 3.

In a preferred embodiment, the detergent contains one or more perfumes in an amount of usually up to 15 wt. %, preferably 0.01 to 5 wt. %, in particular 0.3 to 3 wt. %.

Individual odorant compounds, e.g., synthetic products of the ester, ether, aldehyde, ketone, alcohol and hydrocarbon type, can be used as perfume oils or fragrances. However, mixtures of different odorants are preferably used which together produce an appealing fragrance note. Perfume oils of this kind can also contain natural odorant mixtures, as are obtained from plant sources.

The detergent may be dyed using suitable dyes in order to improve its aesthetic. Preferred dyes, which can be selected by a person skilled in the art without any difficulty at all, are highly stable in storage, unaffected by the other ingredients of the detergent or cleaning agent, insensitive to light and should not exhibit pronounced substantivity with respect to textile fibers, in order to avoid dyeing said fibers.

Examples of suds suppressors that can be used in the detergents include soaps, paraffins or silicone compounds, in particular silicone oils, which may be present as emulsions.

Suitable soil release polymers, which are also referred to as “anti-redeposition agents,” are for example, non-ionic cellulose ethers, such as methylcellulose and methylhydroxypropyl cellulose, having a proportion of methoxy groups of 15 to 30 wt. % and of hydroxypropyl groups of 1 to 15 wt. %, in each case based on the non-ionic cellulose ether, and the polymers of phthalic acid and/or terephthalic acid known from the prior art, or derivatives thereof, in particular polymers of ethylene terephthalates and/or polyethylene glycol terephthalates and/or polypropylene glycol terephthalates or anionically and/or non-ionically modified derivatives thereof. Suitable derivatives comprise the sulfonated derivatives of phthalic acid polymers and terephthalic acid polymers.

The function of graying inhibitors is to keep the dirt that is removed from the fiber suspended in the liquor and in this way prevent redeposition of the dirt. Water-soluble colloids, which are usually organic, are suitable for this purpose, for example sizing material, gelatin, salts of ethersulfonic acids of starch or of cellulose, or salts of acidic sulfuric acid esters of cellulose or of starch. Water-soluble polyamides containing acid groups are also suitable for this purpose. Furthermore, soluble starch preparations and starch products other than those mentioned above can be used, for example degraded starch, aldehyde starches, etc. Polyvinylpyrrolidone is also suitable. Cellulose ethers, such as carboxymethylcellulose (Na salt), methylcellulose, hydroxyalkylcellulose, and mixed ethers, such as methylhydroxyethylcellulose, methylhydroxypropylcellulose, methylcarboxymethylcellulose and mixtures thereof, are used in amounts of 0.1 to 5 wt. %, based on the total weight of the detergent.

Since textile fabrics, in particular made of rayon, viscous staple fiber, cotton and mixtures thereof, can tend to crease because the individual fibers are sensitive to bending, kinking, pressing and squeezing transversely to the fiber direction, the detergents can contain synthetic anti-crease agents. These include, for example, synthetic products based on fatty acids, fatty acid esters, fatty acid amides, alkylol esters, alkylolamides or fatty alcohols, which are usually reacted with ethylene oxide, or products based on lecithin or modified phosphoric esters.

To combat microorganisms, the detergents can contain antimicrobial active ingredients. Here, depending on the antimicrobial spectrum and mechanism of action, a distinction is made between bacteriostatic and bactericidal agents, fungistatic and fungicidal agents, etc. Important substances from these groups are, for example, benzalkonium chlorides, alkyl aryl sulfonates, halophenols and phenylmercuric acetate, although these compounds can also be omitted entirely from the detergents according to the invention.

The detergents according to the invention can contain preservatives, although preferably only those that have little or no skin-sensitizing potential are used. Examples are sorbic acid and the salts thereof, benzoic acid and the salts thereof, salicylic acid and the salts thereof, phenoxyethanol, formic acid and the salts thereof, 3-iodo-2-propynyl butyl carbamate, sodium N-(hydroxymethyl)glycinate, biphenyl-2-ol, and mixtures thereof. Further suitable preservatives are isothiazolones, mixtures of isothiazolones and mixtures of isothiazolones with other compounds, for example tetramethylolglycoluril.

In order to prevent undesired changes to the detergents according to the invention and/or to the treated textile two-dimensional structures caused by the action of oxygen and other oxidative processes, the detergents or cleaning agents can contain antioxidants. This compound class includes, for example, substituted phenols, hydroquinones, catechols and aromatic amines as well as organic sulfides, polysulfides, dithiocarbamates, phosphites, phosphonates and vitamin E.

Increased wearing comfort can result from the additional use of antistatic agents that are additionally added to the detergents. Antistatic agents increase the surface conductivity and thus enable the charges that have formed to flow off better. External antistatic agents are generally substances having at least one hydrophilic molecular ligand and give the surfaces a more or less hygroscopic film. These mostly surface-active antistatic agents can be divided into nitrogen-containing (amines, amides, quaternary ammonium compounds), phosphorus-containing (phosphoric acid esters) and sulfur-containing (alkyl sulfonates, alkyl sulfates) antistatic agents. Lauryl (or stearyl) dimethylbenzylammonium chlorides are suitable as antistatic agents for textile two-dimensional structures or as an additive to washing or cleaning agents, wherein an enhancing effect is additionally achieved.

To improve the rewettability of the treated textile two-dimensional structures and to facilitate ironing of the treated textile two-dimensional structures, silicone compounds, for example, can be used in the detergent. These additionally improve the rinsing behavior of washing or cleaning agents by means of their suds-suppressing properties. Preferred silicone derivatives are, for example, polydialkyl- or alkylarylsiloxanes in which the alkyl groups have one to five C atoms and are completely or partially fluorinated. Preferred silicones are polydimethylsiloxanes which may optionally be derivatized and are then amino-functional or quaternized or have Si—OH, Si—H and/or Si—CI bonds. The viscosities of the preferred silicones are in the range between 100 and 100,000 mPas at 25° C., wherein the silicones can be used in amounts between 0.2 and 5 wt. %, based on the total amount of detergent.

Finally, the detergent can also contain UV absorbers, which are absorbed onto the treated textile two-dimensional structures and improve the light-fastness of the fibers. Compounds which have these desired properties are, for example, the compounds and derivatives of benzophenone which have substituents in the 2- and/or 4-position and are effective by radiationless deactivation. Substituted benzotriazoles, acrylates (cinnamic acid derivatives) that are phenyl-substituted in the 3-position, optionally having cyano groups in the 2-position, salicylates, organic Ni complexes and natural substances, such as umbelliferone and the endogenous urocanic acid, are also suitable.

In order to avoid the decomposition, catalyzed by heavy metals, of particular detergent ingredients, substances can be used that complex heavy metals. Suitable heavy metal complexing agents are, for example, the alkali salts of ethylenediaminetetraacetic acid (EDTA) or nitrilotriacetic acid (NTA), methylglycinediacetic acid trisodium salt (MGDA), and alkali metal salts of anionic polyelectrolytes, such as polymaleates and polysulfonates.

A preferred class of complexing agents are the phosphonates, which are present in the washing or cleaning agent in amounts of 0.01 to 2.5 wt. %, preferably 0.02 to 2 wt. % and in particular 0.03 to 1.5 wt. %. These preferred compounds include in particular organophosphonates, such as 1-hydroxyethane-1,1-diphosphonic acid (HEDP), aminotri(methylenephosphonic acid) (ATMP), diethylenetriaminepenta(methylenephosphonic acid) (DTPMP or DETPMP) and 2-phosphonobutane-1,2,4 tricarboxylic acid (PBS-AM), which are mostly used in the form of their ammonium or alkali metal salts. Alternative complexing agents that can be used in the washing or cleaning agent are iminodisuccinate (IDS) or ethylenediamine-N,N′-disuccinate (EDDS).

“Aqueous” in the scope of the present invention means that water is the main solvent in the detergent according to the invention. However, non-aqueous solvents can be added to this. The detergent or cleaning agent can also be in the form of an emulsion, wherein solid particles can be temporarily mixed with the aqueous phase by shaking.

The detergent according to the invention is preferably single-phase.

The term “liquid” preferably refers to a composition that is flowable at room temperature (approx. 20° C.) and ambient pressure (approx. 1013 mbar at sea level). The term “liquid detergent” or “liquid, aqueous detergent” can also include agents in gel and pasty form.

A substance, for example the detergent, is “solid” if it is in the solid state at room temperature (approx. 20° C.) and ambient pressure (approx. 1013 mbar at sea level).

An important aspect of the invention concerns the pH of the liquid detergent. It is essential that this is in the neutral range, between 6 and 8.5 and preferably between 6.5 and 8. If the pH is outside the range, in particular at pH values greater than 8.5, severe clouding of the agent can directly occur, followed by phase separation.

When reference is made herein to the pH of an agent, this refers to the pH of the washing or cleaning liquor obtainable with the agent when dissolved in distilled water (in a weight ratio of 1:100) at 20° C., unless otherwise stated.

The detergents according to the invention can be used for washing and/or cleaning textile two-dimensional structures.

Any methods known from the prior art are suitable for producing the detergents described herein.

Washing processes, i.e., in particular methods for cleaning textiles, are generally characterized by the fact that, in one or more method steps, cleaning-active substances are applied to the material to be cleaned and washed off after the exposure time, or in that the material to be cleaned is otherwise treated with a detergent or a solution or dilution of this agent.

In washing processes according to the invention, temperatures of up to 95° C. or less, 90° C. or less, 60° C. or less, 50° C. or less, 40° C. or less, 30° C. or less or 20° C. or less can be used in different embodiments of the invention. This temperature information relates to the temperatures used in the washing steps.

In further aspects, the present invention is also directed to the use of the detergent according to the invention for improving the fiber properties of textile two-dimensional structures washed therewith, in particular for reducing the tensile strength loss of textile two-dimensional structures during the washing process.

Furthermore, the present invention is directed to the use of the detergent according to the invention for reducing the tensile strength loss of wool and/or cotton fibers during the washing process.

Further still, the present invention is directed to the use of one or more active ingredients a) and b) for reducing the tensile strength loss of textile two-dimensional structures during the washing process and to a method for reducing the tensile strength loss of textile two-dimensional structures during the washing process, in which the textile two-dimensional structures are washed with a detergent containing
a) at least one alpha-substituted compound of general formula (I)

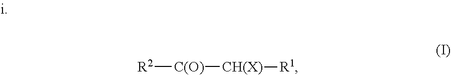

in which
   one of the functional groups R¹ or R² stands for H and the other stands for a straight-chain or branched, saturated or unsaturated alkyl group having 1 to 15 carbon atoms, where the carbon chain can optionally be substituted by one or more hydroxyl or amino groups, and
   X stands for —OH, —NH₂, —Cl, —Br, —I or for the following groupings: —O—(CH₂)ₙ—CH₃, where n means the numbers 1, 2, 3 or 4, and —O—(CH₂)ₘ—OH, where m means the numbers 1, 2 or 3.

All elements, subjects and embodiments described for the detergents according to the invention are also applicable to the uses and methods according to the invention. Therefore, reference is expressly made at this point to the disclosure at the appropriate point with the note that this disclosure also applies to the above-described uses and methods according to the invention.

### EXAMPLES

### 1) Composition of the Detergent (Amounts in [Wt. %])

| | 1 | 2 | 3 | 4 |
|---|---|---|---|---|
| Sodium laureth sulfate | 2.9 | 2.9 | 2.9 | 2.9 |
| C₁₂₋₁₈ alcohol + 7 EO | 3.3 | 3.3 | 3.3 | 3.3 |
| Dodecylbenzenesulfonate, | 2.7 | 2.7 | 2.7 | 2.7 |
| Na salt | | | | |
| C₁₂₋₁₈ fatty acids | 0.5 | 0.5 | 0.5 | 0.5 |
| NaOH solution, 50% | 0.5 | 0.5 | 0.5 | 0.5 |
| Polyquaternium-7 | 0.2 | — | — | — |
| 1-Hydroxyoctan-2-one* | — | 0.5 | 0.05 | — |
| If necessary, other active and | q.s. | q.s. | q.s. | q.s. |
| auxiliary ingredients (e.g., | | | | |
| chelating agents, preservatives, | | | | |
| pH adjusters, enzymes) | | | | |
| Water | up to | up to | up to | up to |
| | 100 | 100 | 100 | 100 |

*EternaLock Bond ®

### 2) Tensile Strength Measurements

Eternalock (hydroxyoctanal and 1-hydroxyoctan-2-one, respectively) was used as the alpha-substituted compound according to formula (I) in formulations 2 and 3.

In comparative formulation 1, the commercially available and well-known textile fiber care agent Polyquaternium-7 was used.

Comparative formulation 4 contains neither Eternalock nor Polyquaternium-7.

All tensile strength loss determinations were performed according to ISO 13934-1:2013

“Tensile properties of fabrics—Part 1: Determination of maximum force and elongation at maximum force using the strip method.”

Market textiles were used (silk, wool (cashmere), cotton and blended textiles—see table below) to determine the tensile strength loss of different textile compositions.

The textiles were washed in a standard washing machine under the following washing conditions:
wool: wool program; 39 min.; 30° C.; 1200 rpm
cellulosic fabrics and mixed textiles: easy-care program; 1:59 h; 40° C.; 1200 rpm

The results of the washing tests can be found in the following table:

| Detergent | Textile | TSL [%]* |
|---|---|---|
| 1 | 100% silk | −12.7 |
| 3 | 100% silk | 3.02 |
| 2 | 100% silk | −10.7 |
| 1 | 100% cashmere | 0.6 |
| 3 | 100% cashmere | 10.7 |
| 2 | 100% cashmere | 11.8 |
| 4 | 100% cotton (Gildan T-shirt) | −21.53 |
| 3 | 100% cotton (Gildan T-shirt) | −23.48 |
| 2 | 100% cotton (Gildan T-shirt) | −15.81 |
| 4 | 100% cotton (Fruit of the Loom T-shirt) | −11.02 |
| 3 | 100% cotton (Fruit of the Loom T-shirt) | −10.26 |
| 2 | 100% cotton (Fruit of the Loom T-shirt) | −5.04 |
| 4 | 48% cotton/48% viscose/4% elastane | −7.39 |
| | (Schöller top) | |
| 3 | 48% cotton/48% viscose/4% elastane | 1.12 |
| | (Schöller top) | |
| 2 | 48% cotton/48% viscose/4% elastane | −5.37 |
| | (Schöller top) | |
| 4 | 95% modal/5% elastane (Cito top) | −16.09 |
| 3 | 95% modal/5% elastane (Cito top) | −18.11 |
| 2 | 95% modal/5% elastane (Cito top) | −11.83 |

*TSL = tensile strength loss

a negative TSL value means a decrease in fiber strength after washing compared to new textiles
a positive TSL value means an increase in fiber strength after washing compared to new textiles
the higher the TSL value, the better:
   If the TSL value is positive, this means that the fiber strength after washing is even better than that of a new textile
   If the TSL value is “less negative” after washing with EternaLock than with a detergent without EternaLock, this means that the fiber strength loss is less pronounced with EternaLock than when washing with a detergent that does not contain EternaLock.

It can be seen that the tensile strength of wool fibers after washing with a detergent containing EternaLock is improved compared to a new wool fabric and compared to the reference (detergent formulation without EternaLock).

It can also be seen that washing cellulosic fabrics and blended textiles with a detergent containing EternaLock reduces the tensile strength loss of these fibers and helps to strengthen and maintain the strength of these fibers.

1. A detergent comprising:
from 0.000001 to 2.0 wt. %, based on the total weight of the detergent, of at least one alpha-substituted compound of general formula (I) 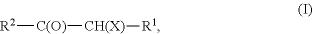
wherein:
one of the functional groups R¹ or R² represents H and the other of the functional groups R¹ or R² represents for a straight-chain or branched, saturated or unsaturated alkyl group having 1 to 15 carbon atoms, where the carbon chain can optionally be substituted by one or more hydroxyl or amino groups, and
X represents —OH, —NH₂, —Cl, —Br, —I, —O—(CH₂)ₙ—CH₃, where n represents 1, 2, 3, or 4, or —O—(CH₂)ₘ—OH, where m represents 1, 2, or 3.

2. The detergent of claim 1, wherein the alpha-substituted compound of general formula (I) is alpha-hydroxyoctanal, alpha-hydroxyoctanone, or a mixture of alpha-hydroxyoctanal and alpha-hydroxyoctanone.

3. The detergent of claim 1, further comprising at least one surfactant present in an amount of from 1 to 40 wt. %, based on the total weight of the detergent.

4. The detergent of claim 1, further comprising at least one further component selected from the group consisting of builders, bleaching agents, bleach catalysts, bleach activators, electrolytes, pH adjusters, perfumes, perfume carriers, fluorescing agents, dyes, hydrotropic substances, complexing agents, suds suppressors, silicone oils, soil release polymers, graying inhibitors, shrinkage preventers, anti-crease agents, antimicrobial active ingredients, solvents, germicides, fungicides, antioxidants, preservatives, corrosion inhibitors, antistatic agents, bittering agents, ironing aids, phobicizing and impregnating agents, skin care active ingredients, anti-swelling and anti-slip agents, softening components, UV absorbers, and any mixture thereof.

5. The detergent of claim 1, wherein the detergent is in solid form, liquid form, or gel form.

6. A method of improving at least one fiber property of a textile during washing, the method comprising using the detergent of claim 1 during the washing of the textile.

7. A method of reducing the tensile strength loss of a textile during washing, the method comprising using the detergent of claim 1 during the washing of the textile.

8. A method of reducing the tensile strength loss of wool and/or cotton fibers during washing, the method comprising using the detergent of claim 1 during the washing of the wool and/or cotton fibers.

9. The detergent of claim 4, wherein the at least one further component is present in an amount of from 0.0001 to 30 wt. %, based on the total weight of the detergent.

10. The detergent of claim 5, wherein the detergent is in aqueous form.

11. The detergent of claim 1, wherein the detergent is in unit dosage form.

12. The detergent of claim 1, wherein:
one of the functional groups R¹ or R² represents H or —(CH₂)ₒ—CH₃, where o represents 3, 4, 5, 6, 7, 8, 9, or 10, and
X represents a hydroxyl group.

13. The detergent of claim 1, further comprising at least one surfactant present in an amount of from 1 to 40 wt. %, based on the total weight of the detergent.

14. The detergent of claim 1, further comprising at least one anionic surfactant.

15. The detergent of claim 14, wherein the at least one anionic surfactant is selected from the group consisting of linear or branched alkylbenzene sulfonates, alkyl ether sulfates, alpha-olefin sulfonates, and any mixture thereof.

16. The detergent of claim 15, wherein the at least one anionic surfactant is at least one linear or branched alkylbenzene sulfonate and at least one alkyl ether sulfate.

17. The detergent of claim 14, wherein the at least one anionic surfactant is present in an amount of from 1 to 15 wt. %, based on the total weight of the detergent.

18. The detergent of claim 1, further comprising at least one non-ionic surfactant.

19. The detergent of claim 18, wherein the at least one non-ionic surfactant is selected from the group consisting of alkoxylated fatty alcohols, alkoxylated fatty acid alkyl esters, fatty acid amides, alkoxylated fatty acid amides, polyhydroxy fatty acid amides, alkylphenol polyglycol ethers, amine oxides, alkyl polyglucosides, and any mixture thereof.

20. The detergent of claim 18, wherein the at least one non-anionic surfactant is present in an amount of from 0.1 to 30 wt. %, based on the total weight of the detergent.
